(19) United States
(12) Patent Application Publication
(10) Pub. No.: US 2025/0376159 A1
(43) Pub. Date: Dec. 11, 2025

(54) Method for operating a lane guidance assistant of a vehicle according to environmental conditions, lane guidance assistant and vehicle

(71) Applicant: Bayerische Motoren Werke Aktiengesellschaft, Muenchen (DE)

(72) Inventor: Alexander GOETZ, Muenchen (DE)

(21) Appl. No.: 18/878,408

(22) PCT Filed: Jun. 22, 2023
(86) PCT No.: PCT/EP2023/067036

§ 371 Date: Dec. 23, 2024

(30) Foreign Application Priority Data
Jun. 24, 2022 (DE) 10 2022 115 860.8

(51) Int. Cl. B60W 30/12; B60W 10/20

(52) U.S. Cl. CPC B60W 30/12; B60W 10/20; B60W 2552/05; B60W 2552/53; B60W 2555/20; B60W 2555/80; B60W 2556/20; B60W 2556/40; B60W 2556/50; B60W 2710/20

(57) ABSTRACT

A method for operating a lane guidance assistant of a vehicle includes the steps of: receiving environmental data which describe an environment of the vehicle; recognizing lane boundaries delimiting a lane in which the vehicle is currently located; automatically performing steering interventions to keep the vehicle in the lane if the lane boundaries are recognized for a predefined debounce time; continually determining environmental conditions, the environmental conditions describing a current location of the vehicle, weather in the environment, a current time of day and/or a road type associated with the lane; and adjusting the debounce time according to the continually determined environmental conditions.

### BACKGROUND AND SUMMARY

The present invention relates to a method for operating a lane guidance assistant of a vehicle. Moreover, the present invention relates to a lane guidance assistant for a vehicle. Finally, the present invention relates to a vehicle having such a lane guidance assistant.

Lane guidance assistants for vehicles are sufficiently well known from the prior art. Such lane guidance assistants, which are also referred to as steering and lane guidance assistants or as active lane-keeping assistants, are used in particular to keep the vehicle within a lane. Such a lane guidance assistant utilizes the environment data from an environment sensor of the vehicle to identify the boundaries of a lane, or lane markings. If such lane markings are identified with adequate certainty, the lane guidance assistant can be activated and steering interventions can be performed to keep the vehicle within the lane. By way of example, the steering interventions can be performed in such a way that the vehicle is kept central within the lane.

The availability of the lane guidance assistant in the known prior art is coupled to various conditions. By way of example, there may be provision for what is known as a debounce time that indicates that the boundaries of the lane, or the road markings, need to be reliably identified over a predefined time. Moreover, it is known for this debounce time to be adapted if the presence or the identification of lane markings by available environment sensors often changes. By way of example, lane markings can be identified repeatedly within a determined period, for example 30 seconds, and can also disappear again. This increase in the debounce time is used to enable the provision of continuous availability of the lane guidance assistant and to avoid frequent changes of state.

The technical problem that accompanies the prior art described is firstly the disadvantage that the availability of the lane guidance assistant is reduced overall because the debounce time temporarily prevents activation of the function. Secondly, the prior art does not take account of current circumstances, or parameters, that affect the operation of the lane guidance assistant. Optimum setting of debounce times cannot be enabled, therefore, and the best possible availability of the function with simultaneous continuity of the functional state is not achieved either.

The object of the present invention is to demonstrate a solution to how a lane guidance assistant of the type cited at the outset can be improved such that availability is increased and at the same time reliability is improved.

This object is achieved according to the invention by a method, by a lane guidance assistant, and by a vehicle having the features according to the independent claim(s). Advantageous developments of the present invention are specified in the dependent claims.

A method according to the invention is used to operate a lane guidance assistant of a vehicle. The method comprises receiving environment data that describe surroundings of the vehicle. Moreover, the method comprises identifying lane boundaries that bound a lane that the vehicle is currently in. Additionally, the method comprises automatically performing steering interventions to keep the vehicle in the lane if the lane boundaries are identified for a predetermined debounce time. Moreover, the method comprises continually determining environmental conditions, the environmental conditions describing a current location of the vehicle, a weather in the surroundings, a current time of day and/or a road type associated with the lane. Furthermore, the method comprises adapting the debounce time on the basis of the continually determined environmental conditions.

The lane guidance assistant is used to assist a driver of the vehicle in steering tasks. In particular, the lane guidance assistant is used to keep the vehicle within the lane, or the current lane. The lane guidance assistant can also be referred to as a steering and lane guidance assistant, as an active lane-keeping assistant or as a steering assistant. The lane guidance assistant can have at least one environment sensor that can be used to provide the environment data. These environment data describe surroundings, or an environment, of the vehicle. By way of example, the environment sensor may be a camera. In the case of a camera, the environment data may be image data.

The lane boundaries can be identified in the environment data. In particular, the lane boundaries that bound the lane that the vehicle is currently in are identified. There may furthermore be provision for lane boundaries of other lanes, or adjacent lanes, to be identified. The lane boundaries may be in particular road markings, for example solid or dashed, or broken, lines. The lane boundary may also be a physical boundary, for example a wall, a crash barrier, a kerbstone or the like. Further, the lane boundary detected may be a grass verge, a gravel bed or the like.

If the lane boundaries are reliably identified for the period of the debounce time with a predetermined probability, or with a predetermined certainty, the functionality of the lane guidance assistant can be activated. This means that the lane guidance assistant is used to provide steering interventions, or to provide an overlap steering torque, to keep the vehicle within the lane. By way of example, the lane guidance assistant can use an active steering system to intervene directly in the driving response. The steering torque provided by the lane guidance assistant, or the steering intervention provided, can be overridden by the driver at any time, however, by operating the steering wheel.

There is provision for the function of the lane guidance assistant to be activated only when the lane boundaries, or the road markings, are identified for the duration of the predetermined debounce time with a predetermined certainty, or probability. The present invention now permits this debounce time to be adapted according to the current environmental conditions. These environmental conditions can firstly describe the current location, or the country, that the vehicle is currently in. Further, the environmental conditions can describe the weather in the surroundings of the vehicle, or the weather conditions in the environment of the vehicle. Alternatively or additionally, the environmental conditions can describe a current time of day, or the lighting conditions in the surroundings of the vehicle. Moreover, the environmental conditions can describe a type of road associated with the road that the lane is on.

There is provision for the environmental conditions to be detected continually, or continuously. By way of example, the environmental conditions can be detected at predetermined times, or in predetermined time intervals. It is thus also possible for the debounce time to be adapted according to the changing environmental conditions. These environmental conditions can be taken as a basis for adapting the debounce time. In this way, continuous availability of the lane guidance assistant can be achieved and frequent changes of state between an active state and a standby state of the lane guidance assistant can be avoided. All in all, the user's satisfaction and customer acceptance can thus be increased.

Preferably, the current location of the vehicle is taken as a basis for determining a country-specific stipulation for the debounce time, and the debounce time is adapted on the basis of the country-specific stipulation. There is thus preferably provision for the environmental conditions to describe the current location, or site, of the vehicle. In particular, the environmental conditions can describe the country that the vehicle is currently in, or that is being driven in. In this case, there is in particular provision for different debounce times to be able to be stored and accordingly retrieved for different countries, or regions. By way of example, the demands of customers and the conditions in the different countries can necessitate the debounce time being set in a manner adapted according to the country. By way of example, there may be provision for shorter debounce times for countries such as China or the USA than a debounce time that is predefined as standard. In this case, the lane guidance assistant, or the steering assistant, can transfer to an actively controlling state earlier if there is stable identification of lane markings and a suitable road. All in all, the different demands of customers in the countries, the states of development of the roads and the like can thus be taken into account.

In a further embodiment, the weather and/or the current time of day is/are taken as a basis for determining a reliability of the identification of the lane boundaries on the basis of the environment data. Furthermore, the debounce time is preferably adapted on the basis of the reliability of the identification. The weather, or the weather data, can be taken as a basis for ascertaining whether the weather conditions limit detection of the lane boundaries, or the lane markings, by the at least one environment sensor. This may be the case for example with rain, snowfall, fog or the like. By way of example, detection of the lane boundaries by means of the environment sensors may be impaired by a precipitation. There may also be provision for precipitation, for example snow and/or ice, to have settled in the lane and thus for detection of the lanes, or the lane boundaries, not to be possible or to be possible only to a very limited degree. Furthermore, a wet road surface can result in a reflection arising that likewise impairs detection of the road markings by means of the environment sensor.

The current time of day can be taken as a basis for detecting in particular the lighting situation in the surroundings. This lighting situation, or brightness, in the surroundings can also influence detection of the lane boundaries by means of the environment sensor. By way of example, detection of the road boundaries may be severely impaired at dusk and at night. Strong insolation can also significantly worsen detection of the lane boundaries. All in all, the weather data and/or the current time of day can be taken as a basis for ascertaining whether detection of the lane boundaries by means of the environment sensor is impaired in comparison to a defined normal state. This can then be taken into account for adapting the debounce time.

In this case, there is in particular provision for the debounce time to be increased if the reliability of the identification is lower than a predetermined average value. In bad weather, which is received on the basis of the environment data, or the sensor data, of the at least one environment sensor or from a weather report, the debounce time is increased. Here, there is the risk of unstable identification of the lanes, or the lane boundaries, and therefore of a changing functional state and also the risk of incorrect control of the vehicle due to inadequate environment data. This applies equally to driving at dusk or during the night.

Furthermore, it is advantageous if the debounce time is increased if the road type is consistent with a freeway. There is thus preferably provision for the debounce time to be shortened on freeways, as stable and easily visible lane markings, or lane boundaries, can be assumed here. The same applies to the road type expressway, highway or the like. In principle, the state of development of a road and the customary or known presence of road markings, or lane boundaries, can be used. By way of example, digital map data or environment data from other vehicles can be used that describe the quality of the road markings. Moreover, it is possible to take into account when the road was constructed, or whether the road has been renovated. The debounce time can thus be ideally adapted according to the current road type.

In a further embodiment, the environmental conditions are determined on the basis of the environment data, on the basis of satellite-based position data, on the basis of digital map data and/or on the basis of weather data. To be able to determine the environmental conditions, the environment data, or the sensor data, of the at least one environment sensor can be used directly. By way of example, it is thus possible to identify whether there is a precipitation in the surroundings of the vehicle. It is furthermore possible to establish whether precipitation has settled on the road surface. To determine the current weather, or the weather data, it is furthermore possible to receive weather data from an appropriate transmitting station, a backend or the like. To determine the current time of day, data of a clock and/or data of a light sensor or the like can be taken into account. To be able to determine the current position, or the current location, of the vehicle, digital map data and/or satellite-based position determination systems can be utilized. In this way, the environmental conditions can be ascertained reliably.

A lane guidance assistant for a vehicle, according to the invention, is configured to receive environment data that describe surroundings of the vehicle. Moreover, the lane guidance assistant is configured to identify lane boundaries that bound a lane that the vehicle is currently in. In addition, the lane guidance assistant is configured to perform automatic steering interventions to keep the vehicle in the lane if the lane boundaries are identified for a predetermined debounce time. Further, the lane guidance assistant is configured to continually determine environmental conditions, the environmental conditions describing a current location of the vehicle, a weather in the surroundings, a current time of day and/or a road type associated with the lane. Additionally, the lane guidance assistant is configured to adapt the debounce time on the basis of the continually determined environmental conditions.

The environment data can be provided using at least one environment sensor of the vehicle, or of the lane guidance assistant. By way of example, this environment sensor may be in the form of a camera. There may further be provision for the environment sensor to be in the form of an optical sensor, an infrared sensor or a lidar sensor. The lane guidance assistant may furthermore have a corresponding computing device, which may be formed by an electronic control unit of the vehicle, for example. This computing device can be used to execute an appropriate program, or computer program. In this way, the lane boundaries can be determined on the basis of the environment data.

Moreover, the lane guidance assistant can have a receiver for receiving weather data, for receiving data from a backend or the like. There may furthermore be provision for the lane guidance assistant to have a satellite-based position determination system. The computing device can then be used to determine the environmental conditions and to adapt the debounce time on the basis of the continually determined environmental conditions.

Moreover, the lane guidance assistant can have an appropriate actuator that can be used to perform the steering interventions, or to provide an additional steering torque.

A vehicle according to the invention comprises a lane guidance assistant according to the invention. The vehicle is in particular in the form of an automobile.

The preferred embodiments presented with reference to the method according to the invention and the advantages of said embodiments apply, mutatis mutandis, to the lane guidance assistant according to the invention and to the vehicle according to the invention.

Further features of the invention become apparent from the claims, the figures and the description of the figures. The features and combinations of features cited in the description hereinabove and the features and combinations of features cited in the description of the figures hereinbelow and/or shown in the figures alone can be used not only in the respectively indicated combination but also in other combinations or on their own without departing from the scope of the invention.

The invention will now be explained in more detail on the basis of preferred exemplary embodiments and with reference to the accompanying drawings.

### BRIEF DESCRIPTION OF THE DRAWINGS

FIG. 1 is a schematic representation of a vehicle that has a lane guidance assistant; and

FIG. 2 shows the vehicle in accordance with FIG. 1, which is in a lane.

### DETAILED DESCRIPTION OF THE DRAWINGS

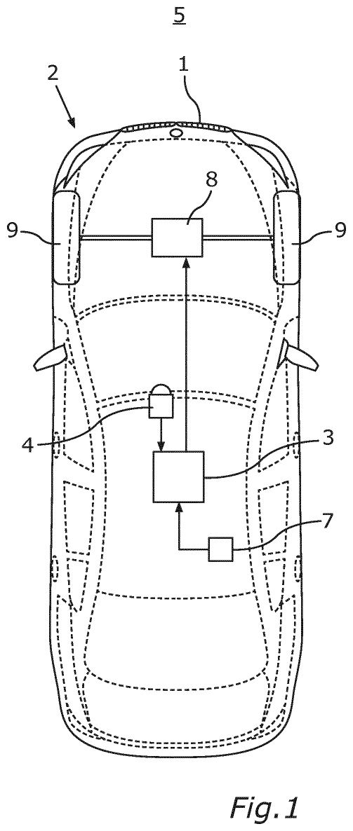

FIG. 1 shows a plan view of a vehicle 1, which is in the form of an automobile in the present case. The vehicle 1 comprises a lane guidance assistant 2 that can be used to keep the vehicle 1 within a lane 6. The lane guidance assistant 2 comprises a computing device 3, which may be formed by at least one electronic control unit of the vehicle 1, for example.

Moreover, the lane guidance assistant 2 comprises at least one environment sensor 4. In the example shown, the lane guidance assistant 2 comprises an environment sensor 4, which is in the form of a camera in the present case. The environment sensor 4 can be used to provide environment data, or image data, that describe surroundings 5 of the vehicle 1. In addition, the lane guidance assistant 2 comprises a receiving device 7 that can be used to receive weather data, for example. Furthermore, the receiving device 7 can be used to receive data from a backend, from the Internet, from a radio station or the like. In addition, the receiving device 7 can be used to receive data from a satellite-based position determination system. Instead of the illustrative receiving device 7, multiple individual receiving devices can also be used.

The computing device 3 is furthermore configured to control a steering system 8, shown only schematically in the present case, of the vehicle 1. Controlling the steering system 8 allows a steering torque, or a steering intervention, to be produced to keep the vehicle 1 in the lane 6. Controlling the steering system 8 allows steerable wheels 9 of the vehicle 1 to be steered and thus the lateral guidance of the vehicle 1 to be influenced.

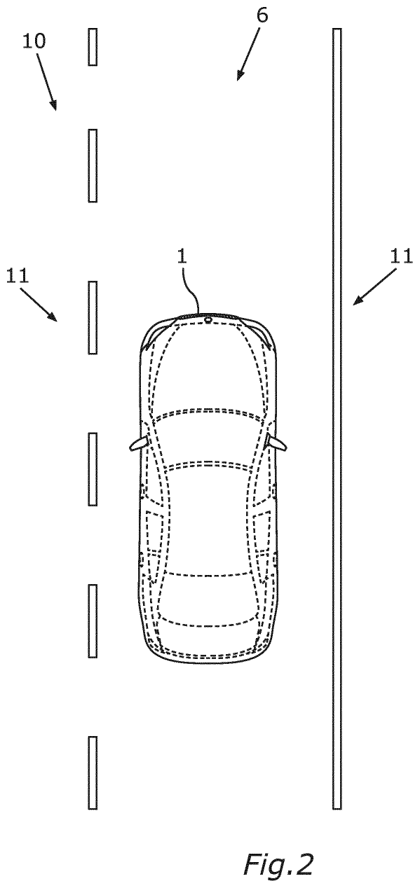

FIG. 2 shows a schematic representation of the vehicle 1, which is in a lane 6. This lane 6 is associated with a road 10. The lane 6 is bounded by lane boundaries 11. The lane boundaries 11 are appropriate road markings applied to the surface of the road. The computing device 3 can be used to take the environment data provided using the environment sensor 4 as a basis for identifying these lane boundaries 11, or road markings.

If these lane boundaries 11 are identified for a predetermined debounce time with a predetermined probability, or certainty, the functionality of the lane guidance assistant 2 can be activated. This is accomplished by virtue of the lane guidance assistant 2 performing appropriate steering interventions in the steering system 8 so that the vehicle 1 is guided centrally within the lane 6, for example.

Furthermore, there is provision for the computing device 3 to be used to detect environmental conditions and to adapt the debounce time on the basis of the detected environmental conditions. In this case, there is in particular provision for the environmental conditions to be determined continually, or at defined times, and then for the debounce time to be adapted if necessary. In this way it is possible to react to changing ambient conditions, or environmental conditions, and thus to avoid frequent changes of state between an active state and a standby state of the lane guidance assistant 2.

The environmental conditions can firstly describe the current location, or the position, of the vehicle 1. The current location can be determined on the basis of satellite-based position data and/or digital map data. Moreover, the environmental conditions can describe the weather in the surroundings 5 of the vehicle 1. The weather in the surroundings 5 can be determined on the basis of the environment data of the environment sensor 4 or on the basis of weather data received by means of the receiving device 7. In addition, the environmental conditions can describe a current time of day, or a lighting situation in the surroundings 5. These data regarding the current time of day or the lighting can likewise be determined by means of the environment sensor 4 or on the basis of time data or the like. Finally, the environmental conditions can describe a road type of the road 10 associated with the lane 6. The determined environmental conditions can then be taken as a basis for adapting the debounce time. This means in particular that the debounce time can be increased or reduced.

An example relating to adapting the debounce time on the basis of environmental conditions is described hereinbelow: it is assumed that the vehicle 1 is currently in China. Due to greater demands on the availability of assistance systems on the Chinese market, the debounce time for activating the lane guidance assistant 2 in this vehicle 1 is reduced by half from a standard value for the debounce time. This leads to faster activation of the lane guidance assistant 2 after the lane boundaries 11 have been identified and thus increases availability. While the vehicle 1 is travelling, it begins to rain. This weather condition is identified by means of the lane guidance assistant 2 and consequently leads to an increase in the debounce time. By way of example, the debounce time can be doubled on the basis of the identified rain. After some time, darkness falls and the rain stops. The darkness means that the debounce time is doubled once again. The debounce time is thus adapted as follows: standard value*0.5 (country)*2 (rain)*2 (darkness). The driver then drives onto the freeway, which is in turn identified by the lane guidance assistant 2 and leads to the debounce time being halved: standard value*0.5 (country)*2 (rain)*2 (darkness)*0.5 (freeway).

Taking these factors into account achieves improved availability of the steering assistant, or the lane guidance assistant 2, which adapts itself according to the common demands of the country-specific market and at the same time permits dynamic adaptation according to given conditions.

1.-8. (Canceled)

9. A method for operating a lane guidance assistant of a vehicle, the method comprising the steps of:
receiving environment data that describe surroundings of the vehicle;
identifying lane boundaries that bound a lane in which the vehicle is currently located;
automatically performing steering interventions to keep the vehicle in the lane when the lane boundaries are identified for a predetermined debounce time;
continually determining environmental conditions, the environmental conditions describing a current location of the vehicle, a weather in the surroundings, a current time of day, and/or a road type associated with the lane; and
adapting the debounce time based on the continually determined environmental conditions.

10. The method according to claim 9, wherein
the current location of the vehicle is taken as a basis for determining a country-specific stipulation for the debounce time, and
the debounce time is adapted based on the country-specific stipulation.

11. The method according to claim 10, wherein
the weather and/or the current time of day is/are taken as a basis for determining a reliability of the identification of the lane boundaries based on the environment data, and
the debounce time is adapted based on the reliability of the identification.

12. The method according to claim 11, wherein
the debounce time is increased when the reliability of the identification is lower than a predetermined average value.

13. The method according to claim 9, wherein
the weather and/or the current time of day is/are taken as a basis for determining a reliability of the identification of the lane boundaries based on the environment data, and
the debounce time is adapted based on the reliability of the identification.

14. The method according to claim 13, wherein
the debounce time is increased when the reliability of the identification is lower than a predetermined average value.

15. The method according to claim 9, wherein
the debounce time is increased if the road type is consistent with a freeway.

16. The method according to claim 9, wherein
the environmental conditions are determined based on the environment data, satellite-based position data, digital map data, and/or weather data.

17. A lane guidance assistant for a vehicle, comprising: a computer-implemented lane guidance assistant operatively configured to:
receive environment data that describe surroundings of the vehicle,
identify lane boundaries that bound a lane in which the vehicle is currently located,
perform steering interventions to keep the vehicle in the lane when the lane boundaries are identified for a predetermined debounce time,
continually determine environmental conditions, the environmental conditions describing a current location of the vehicle, a weather in the surroundings, a current time of day, and/or a road type associated with the lane, and
adapt the debounce time on the basis of the continually determined environmental conditions.

18. A vehicle comprising a lane guidance assistant according to claim 17.
